(19) United States
(12) Patent Application Publication
(10) Pub. No.: US 2026/0052216 A1
(43) Pub. Date: Feb. 19, 2026

(54) DATA PROCESSING APPARATUS, METHOD OF CONTROLLING DATA PROCESSING APPARATUS, AND STORAGE MEDIUM

(71) Applicant: CANON KABUSHIKI KAISHA, Tokyo (JP)

(72) Inventor: Satoru Nakajima, Ibaraki (JP)

(21) Appl. No.: 19/369,768

(22) Filed: Oct. 27, 2025

Related U.S. Application Data
(63) Continuation of application No. 18/050,426, filed on Oct. 27, 2022.

(30) Foreign Application Priority Data
Oct. 29, 2021 (JP) 2021-177093

(51) Int. Cl. H04N 1/00

(52) U.S. Cl. CPC H04N 1/00474; H04N 1/00411

(57) ABSTRACT

A method of controlling a data processing apparatus includes displaying a first button to call a first setting previously registered by a user, receiving change operation to change the first setting, performing execution processing to execute a job after operation to the first button by the user is received, and performing, based on a fact that the job subjected to the execution processing is a job based on a second setting changed from the first setting by the change operation, predetermined control for newly displaying a second button different from the first button to call a setting corresponding to the job subjected to the execution processing, and not performing the predetermined control in a case where the job subjected to the execution processing is a job based on the first setting.

### CROSS-REFERENCE TO RELATED APPLICATIONS

This application is a Continuation of U.S. patent application Ser. No. 18/050,426, filed Oct. 27, 2022, which claims the benefit of Japanese Patent Application No. 2021-177093, filed Oct. 29, 2021, both of which are hereby incorporated by reference herein in their entirety.

### BACKGROUND

### Field of the Disclosure

The present disclosure relates to a data processing apparatus, a method of controlling the data processing apparatus, and a storage medium.

### Description of the Related Art

In recent years, with popularization of a high-performance mobile terminal called a smartphone, an image forming apparatus cooperating with the mobile terminal has also increased. For example, a print job execution instruction can be issued from the mobile terminal to the image forming apparatus by using wireless communication. The mobile terminal receives operation from a user, creates print job information based on selected print data and setting information on various kinds of jobs (e.g., color setting, information on number of prints), and transmits the print job information to the image forming apparatus, thereby causing the image forming apparatus to perform print processing. At this time, network communication between the mobile terminal and the image forming apparatus is established based on a communication protocol of, for example, a wireless local area network (LAN), near field communication (NFC), or Bluetooth®, and can be realized by a well-known technique. Japanese Patent Application Laid-Open No. 2011-258216 discusses a method to improve usability in a case where a user previously registers setting information on a job as a “favorite” in a terminal, and calls the registered “favorite”in the terminal to cause the image forming apparatus to perform the job.

By the method discussed in Japanese Patent Application Laid-Open No. 2011-258216, however, the setting information registered in the terminal by the user may include setting that can result in an execution error, and unusable setting information may be registered in the terminal.

### SUMMARY

Embodiments of the present disclosure are directed to a method for registering usable job setting information in a terminal. According to embodiments of the present disclosure, a method of controlling a data processing apparatus includes displaying a first button to call a first setting previously registered by a user, receiving change operation to change the first setting, performing execution processing to execute a job after operation to the first button by the user is received, and performing, based on a fact that the job subjected to the execution processing is a job based on a second setting changed from the first setting by the change operation, predetermined control for newly displaying a second button different from the first button to call a setting corresponding to the job subjected to the execution processing, and not performing the predetermined control in a case where the job subjected to the execution processing is a job based on the first setting.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an information processing system.

FIG. 2 is a block diagram illustrating a hardware configuration of a data processing apparatus.

FIG. 3 is a block diagram illustrating a hardware configuration of an image forming apparatus.

FIG. 4 is a block diagram illustrating a software configuration of the data processing apparatus.

FIG. 5 is a block diagram illustrating a software configuration of the image forming apparatus.

FIG. 6 is a flowchart illustrating processing by the data processing apparatus for establishing connection with the image forming apparatus.

FIG. 7 is a flowchart illustrating processing by the data processing apparatus to receive job setting from a user.

FIG. 8 is a flowchart illustrating processing by the data processing apparatus to transmit job information to the image forming apparatus.

FIG. 9 is a flowchart illustrating processing by the image forming apparatus to receive the job information.

FIG. 10 is a flowchart illustrating processing by the data processing apparatus in response to a result of the job information reception by the image forming apparatus.

FIGS. 11A to 11F each illustrate an example of an operation screen displayed on a display of the data processing apparatus.

FIG. 12 is a diagram illustrating an example of a job information table of the data processing apparatus.

FIGS. 13A and 13B each illustrate an example of the operation screen displayed on the display of the data processing apparatus.

### DESCRIPTION OF THE EMBODIMENTS

Some exemplary embodiments of the present disclosure are described below with reference to drawings. The following exemplary embodiments do not limit the disclosure, and all of combinations of characteristics described in the exemplary embodiments are not necessarily essential for solving means of the disclosure. In the following description, an image forming apparatus is used as an example of an information processing apparatus; however, the information processing apparatus is not limited thereto.

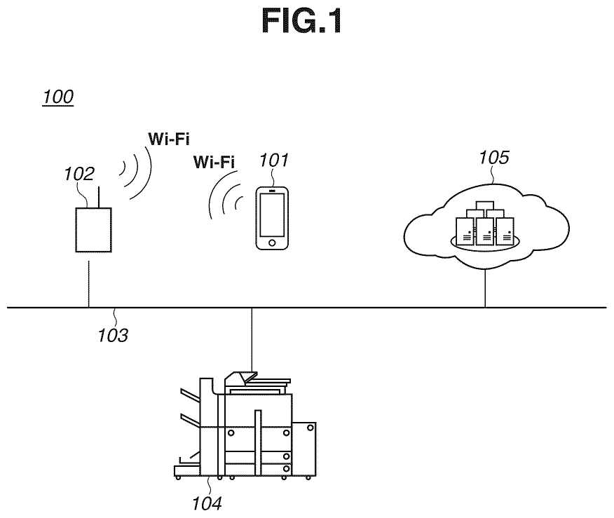

FIG. 1 is a diagram illustrating a configuration of an information processing system according to a first exemplary embodiment. An information processing system 100 includes a data processing apparatus 101, a wireless local area network (LAN) terminal 102, an image forming apparatus 104, and a cloud server 105 that are connected to one another via a network 103.

The data processing apparatus 101 is a mobile terminal such as a smartphone. An operating system for a small terminal and programs controlling calls and data communication may operate in the data processing apparatus 101. Alternatively, the data processing apparatus 101 may be a personal computer (PC) not including sound control, positional detection control, mobile telephone data communication, and the like. The data processing apparatus 101 is connected to the network 103 via the wireless LAN terminal 102. The wireless LAN terminal 102 is a wireless LAN base unit including a common network/router function, and provides wireless LAN in a home, an office, and the like. The image forming apparatus 104 is a digital multifunctional peripheral including various kinds of job execution functions such as a printer function, a copy function, a scanner function, and a facsimile transmission function. A user can instruct the image forming apparatus 104 to execute a job and can perform various kinds of functions of the image forming apparatus 104 by operating the data processing apparatus 101.

The cloud server 105 performs management of data to be used by the data processing apparatus 101 and the image forming apparatus 104, extension processing of the various kinds of functions, and the like via the network 103. In the present exemplary embodiment, the image forming apparatus 104 and the cloud server 105 are connected to the network 103 by a cable, but may be wirelessly connected to the network 103 by using the wireless LAN terminal 102 as with the data processing apparatus 101. Further, the data processing apparatus 101 and the image forming apparatus 104 can perform short-range wireless communication via wireless signals of near field communication (NFC), Bluetooth® Low energy (Bluetooth® LE), or the like. The image forming apparatus 104 holds information (internet protocol (IP) address, media access control (MAC) address, etc.) for wireless LAN connection with the image forming apparatus 104, in an NFC communication unit and a Bluetooth® LE communication unit described below, and the data processing apparatus 101 acquires connection information via the short-range wireless communication. Further, the communication between the data processing apparatus 101 and the image forming apparatus 104 is started based on the acquired information.

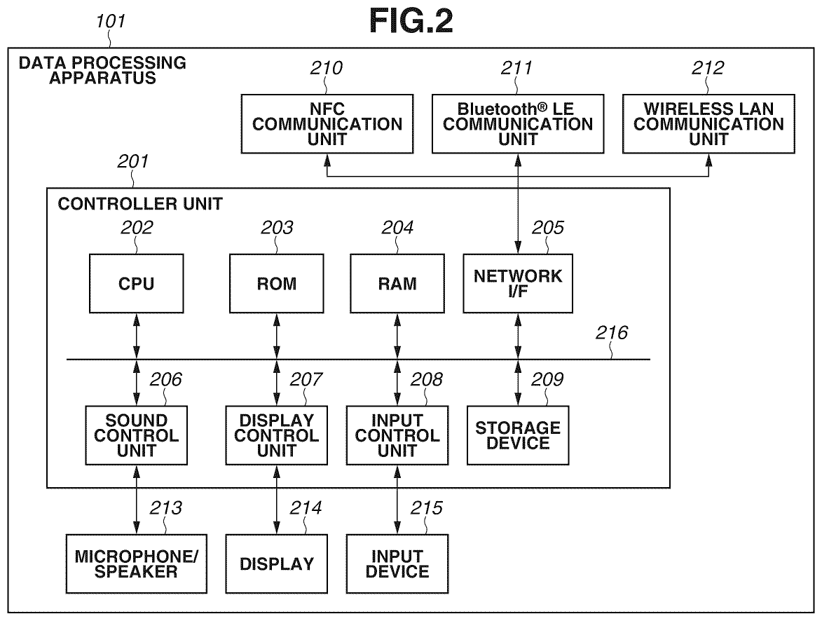

FIG. 2 is a hardware configuration diagram of the data processing apparatus 101 according to the present exemplary embodiment. The data processing apparatus 101 includes a controller unit 201. The controller unit 201 controls various kinds of communication units including an NFC communication unit 210, a Bluetooth® LE communication unit 211, and a wireless LAN communication unit 212, and various kinds of user interface (UI) units including a microphone/speaker 213, a display 214, and an input device 215.

The controller unit 201 includes a central processing unit (CPU) 202, a read only memory (ROM) 203, a random access memory (RAM) 204, a network interface (I/F) 205, a sound control unit 206, a display control unit 207, an input control unit 208, and a storage device 209 that are connected via a system bus 216.

The CPU 202 controls an entire system of the data processing apparatus 101. The ROM 203 stores an operating system of the data processing apparatus 101 and programs controlling calls, data communication, and the like. The CPU 202 executes various kinds of programs. The RAM 204 is used as a temporary storage area such as a main memory and a work area for the CPU 202.

The storage device 209 is a non-volatile storage device, and records setting of various kinds of operation modes, operation logs, and the like to be held after restart of the data processing apparatus 101.

The network I/F 205 is connected to the NFC communication unit 210, the Bluetooth® LE communication unit 211, and the wireless LAN communication unit 212, and exchanges data with the image forming apparatus 104 via various kinds of wireless communication.

The sound control unit 206 performs input/output control of sound data via the microphone/speaker 213. The display control unit 207 performs output control of a screen to be displayed on the display 214. The input control unit 208 performs input control of information instructed by the user via the input device 215 such as buttons and a touch panel. Various kinds of applications executed by the data processing apparatus 101 use the sound control unit 206, the display control unit 207, the input control unit 208, and the like.

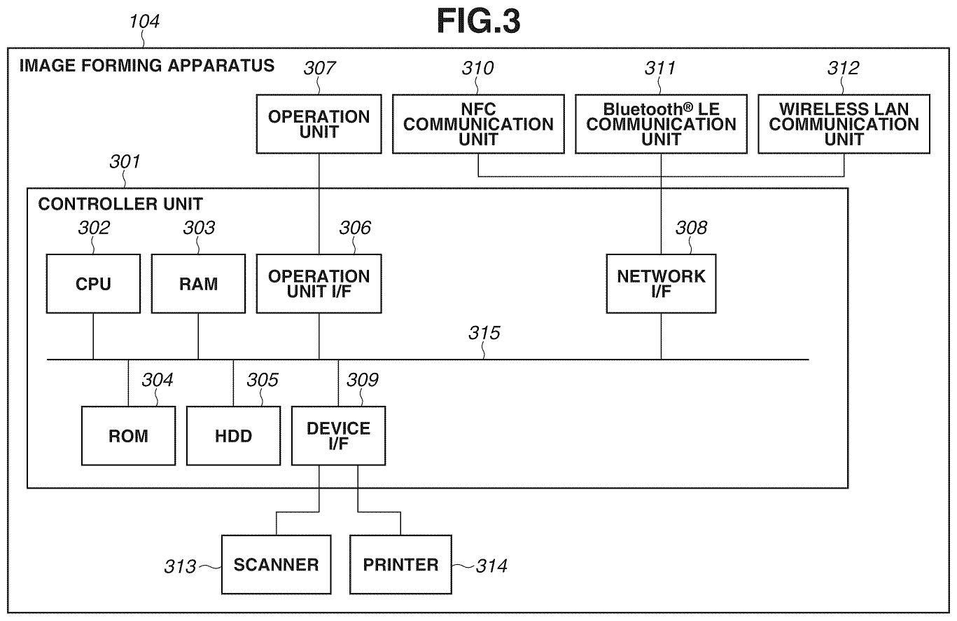

FIG. 3 is a hardware configuration diagram of the image forming apparatus 104 according to the present exemplary embodiment. The image forming apparatus 104 includes a controller unit 301. The controller unit 301 controls various kinds of communication units including an NFC communication unit 310, a Bluetooth® LE communication unit 311, and a wireless LAN communication unit 312, an operation unit 307, a scanner 313, and a printer 314. In a case where the user uses a copy function of the image forming apparatus 104, the controller unit 301 controls the scanner 313 to acquire image data on a document, and controls the printer 314 to print and output an image on a sheet. In a case where the user uses a scan and transmission function, the controller unit 301 controls the scanner 313 to acquire image data on a document, and converts the image data into code data. Further, the controller unit 301 transmits the code data to the data processing apparatus 101 or the like via a network I/F 308. In a case where the user uses a print function, the controller unit 301 receives image data (code data) from the data processing apparatus 101 via the network I/F 308. Thereafter, the controller unit 301 transmits the received image data to the printer 314. The printer 314 prints and outputs an image on a sheet based on the received image data. The image forming apparatus 104 also includes a facsimile (FAX) reception function to receive data from integrated services digital network (ISDN) or the like to perform printing, and a FAX transmission function to transmit scan data to the ISDN or the like. A processing target work, setting and the like of which are performed by the user in order to perform each of the above-described various functions, is called a job, and the image forming apparatus 104 executes a predetermined job based on job information.

The controller unit 301 includes a CPU 302, a RAM 303, a ROM 304, a hard disk drive (HDD) 305, an operation unit I/F 306, the network I/F 308, and a device I/F 309 that are connected via a system bus 315.

The CPU 302 controls an entire system of the image forming apparatus 104. The RAM 303 is a system work memory for operation of the CPU 302, and temporarily stores image data and the like.

Further, the RAM 303 stores scan image data read by the scanner 313, and stores print image data received from the data processing apparatus 101 via the network 103.

The ROM 304 stores a system boot program, applications, and the like. The HDD 305 stores an operating system, system software, application software, image data, setting data, and the like.

The operation unit 307 displays information to the user and receives operation from the user.

For example, the operation unit 307 includes an operation panel such as a touch panel display.

The operation unit I/F 306 outputs information to be displayed on the operation unit 307, to the operation unit 307.

Further, the operation unit I/F 306 receives information input by the user from the operation unit 307. The network I/F 308 is connected to the NFC communication unit 310, the Bluetooth® LE communication unit 311, and the wireless LAN communication unit 312, and exchanges information with the data processing apparatus 101 and the cloud server 105 via various kinds of communication. The wireless LAN communication unit 312 performs wireless LAN communication with the data processing apparatus 101 via the network 103. The NFC communication unit 310 and the Bluetooth® LE communication unit 311 each perform short-range wireless communication with the data processing apparatus 101. The image forming apparatus 104 receives job setting information, image data, a job execution command, and the like from the data processing apparatus 101 via the network I/F 308, and executes a job. The device I/F 309 connects the controller unit 301 to the scanner 313 and the printer 314 that perform reading and printing of image data, and performs input/output of image data.

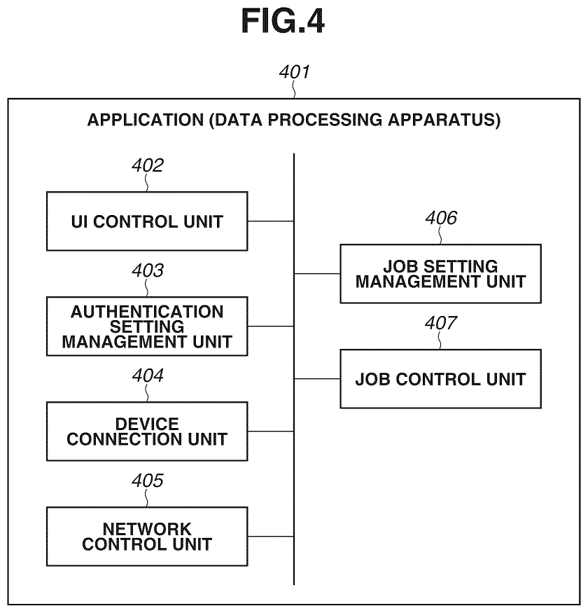

FIG. 4 illustrates a configuration of an application of the data processing apparatus 101 according to the present exemplary embodiment. FIG. 4 is a functional block diagram of software implemented when the CPU 202 reads out control programs stored in the ROM 203 and the storage device 209.

An application 401 is an application installed in the data processing apparatus 101, and is an application to instruct the image forming apparatus 104 to perform operation. Print job information and scan job information can be generated with setting performed on the application 401, and the job information can be transmitted to the image forming apparatus 104. In addition to the application 401, various applications are installed in the data processing apparatus 101; however, descriptions of the applications are omitted. A configuration of the application 401 is described below.

A UI control unit 402 receives job setting information and the like input by the user via the input device 215, and transmits received contents to a job setting management unit 406 and a job control unit 407 via the input control unit 208. Further, the UI control unit 402 receives responses from the job setting management unit 406 and the job control unit 407, and outputs a screen corresponding to received contents to the display 214 via the display control unit 207. Further, the UI control unit 402 receives authentication information to log in the image forming apparatus 104, such as user information and a password input by the user via the input device 215, and transmits the authentication information to an authentication setting management unit 403 via the input control unit 208.

The authentication setting management unit 403 registers the authentication information such as the user information received from the UI control unit 402. Further, the authentication setting management unit 403 performs processing to log in to the image forming apparatus 104 based on the registered authentication information. More specifically, the authentication setting management unit 403 transfers the authentication information to a network control unit 405. The authentication information is transmitted to the image forming apparatus 104 via the network 103. The image forming apparatus 104 performs login processing by using the received authentication information, and returns a result to the data processing apparatus 101. The registered authentication information can be imparted when the job information is transmitted.

A device connection unit 404 establishes, for example, short-range wireless communication using NFC or Bluetooth® LE, or wireless LAN communication via the network 103, between the data processing apparatus 101 and the image forming apparatus 104. For example, in a case of NFC, the short-range wireless communication is started when the user brings the NFC communication unit 210 of the data processing apparatus 101 close to the NFC communication unit 310 of the image forming apparatus 104. In a case of Bluetooth® LE, the Bluetooth® LE communication unit 311 of the image forming apparatus 104 transmits a Bluetooth® LE beacon, and the Bluetooth® LE communication unit 211 of the data processing apparatus 101 receives the transmitted beacon. When the user brings the data processing apparatus 101 close to the image forming apparatus 104, and the data processing apparatus 101 determines that radio wave intensity of the received beacon becomes greater than or equal to predetermined intensity, the short-range wireless communication is started. As described above, when the user brings the data processing apparatus 101 close to the NFC or Bluetooth® LE communication unit of the image forming apparatus 104, the device connection unit 404 performs the short-range wireless communication with the image forming apparatus 104. Further, the device connection unit 404 acquires apparatus information including connection information necessary for the wireless LAN communication, from the image forming apparatus 104 via the short-range wireless communication. The device connection unit 404 starts the wireless LAN communication with the image forming apparatus 104 via the network 103 by using the acquired connection information.

The network control unit 405 transmits job information (setting information, job execution instruction command, image data, user authentication information, etc.) to the image forming apparatus 104 via the network 103. In a case of configuring the job information to transmit scan image data to a set destination, the job setting information includes setting about a destination (e.g., mail address) to which data is to be transmitted, and setting about scanning (e.g., color setting resolution). Further, the network control unit 405 can also receive the job setting information and the like stored in the image forming apparatus 104 via the network 103.

The job setting management unit 406 stores the job setting information that is input by the user and received by the UI control unit 402, and the job setting information received from the image forming apparatus 104 by the network control unit 405, in the RAM 204 and the storage device 209. At this time, the job setting management unit 406 may register the job setting information as a “favorite” setting frequently used by the user. Further, the job setting management unit 406 may register predetermined job setting information as “preset”when the application 401 is installed.

The job control unit 407 controls processing performed by the image forming apparatus 104. For example, the job control unit 407 generates job information from the job setting information included in the “favorite” or the “preset” registered by the job setting management unit 406 or the job setting information set by user operation, and transmits a job execution instruction to the image forming apparatus 104 via the network 103. Further, the job control unit 407 acquires a job execution state and a device operation state of the scanner 313 and the printer 314 from the image forming apparatus 104 via the network 103, and transmits the job execution state and the device operation state to the UI control unit 402.

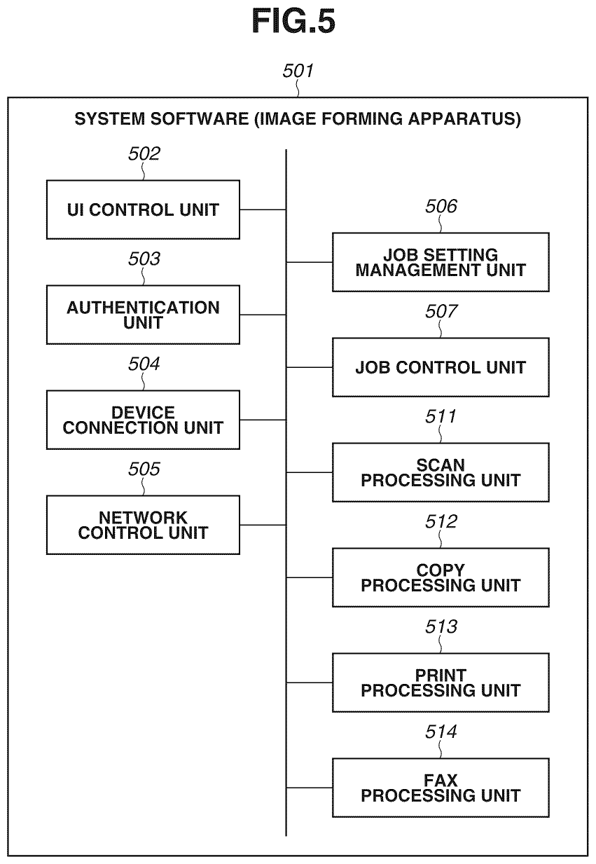

FIG. 5 illustrates a software configuration of the image forming apparatus 104 according to the present exemplary embodiment. FIG. 5 is a functional block diagram of software implemented when the CPU 302 reads out control programs stored in the ROM 304 and the HDD 305.

System software 501 is software executed by the CPU 302 of the image forming apparatus 104, and is stored in the RAM 303. A UI control unit 502 receives job setting information and the like input by the user via the operation unit 307, and transfers the job setting information and the like to a job setting management unit 506 and a job control unit 507. Further, the UI control unit 502 receives responses from the job setting management unit 506 and the job control unit 507, and outputs a screen based on the responses to the operation unit 307.

An authentication unit 503 performs login processing based on the authentication information received from the data processing apparatus 101, and returns a result of the login processing. The image forming apparatus 104 holds various kinds of information such as a mail address, corresponding to the logged in user.

A device connection unit 504 establishes, for example, wireless LAN communication with the data processing apparatus 101. A network control unit 505 receives the job setting information, the job execution instruction command, the image data, the user authentication information, and the like from the data processing apparatus 101 via the network 103. Further, the network control unit 505 transmits the job setting information stored in the image forming apparatus 104 to the data processing apparatus 101 via the network 103.

The job setting management unit 506 manages a state and the like of the job to be executed. Further, the job setting management unit 506 stores information about a job including the job setting information input by the user via the UI control unit 502 and the job setting information received from the data processing apparatus 101 via the network control unit 505, in the RAM 303 and the HDD 305. At this time, the job setting management unit 506 may register the job setting information as a “favorite” setting frequently used by the user. Further, the job setting management unit 506 may register predetermined job setting information as “preset”. In addition, the job setting management unit 506 manages the job executed by the image forming apparatus 104 as a “history”.

The job control unit 507 controls a scan processing unit 511, a copy processing unit 512, a print processing unit 513, and a fax processing unit 514 based on the received job information, and executes various kinds of jobs. For example, the job control unit 507 executes the various kinds of jobs by using the job setting information set by the user via the operation unit 307, and the job setting information such as the “favorite” and the “preset” registered by the job setting management unit 506. Further, the job control unit 507 receives the job execution request from the data processing apparatus 101 or the like via the network 103, and executes the various kinds of jobs based on the received job setting information and the received job execution instruction. Further, the job control unit 507 transmits the job execution state and the device operation state of the scanner 313 and the printer 314 to the data processing apparatus 101 via the network 103.

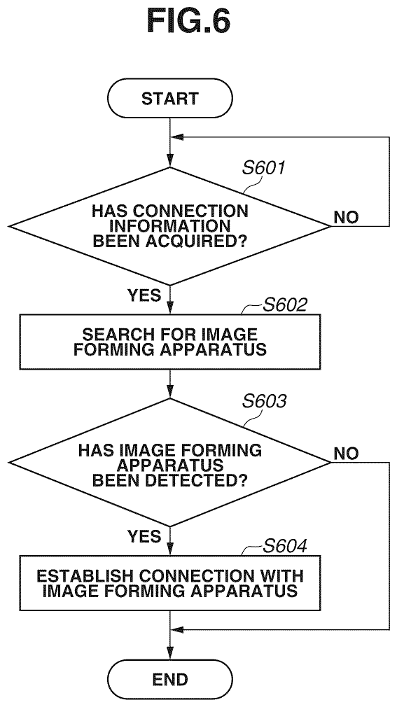

FIG. 6 is a flowchart illustrating processing by the data processing apparatus 101 to establish connection with the image forming apparatus 104. Operation illustrated in FIG. 6 is realized when the CPU 202 reads out programs to implement control modules, stored in the ROM 203 or the storage device 209 to the RAM 204, and executes the programs. The data processing apparatus 101 can issue the job execution instruction to the image forming apparatus 104 connected by the connection processing.

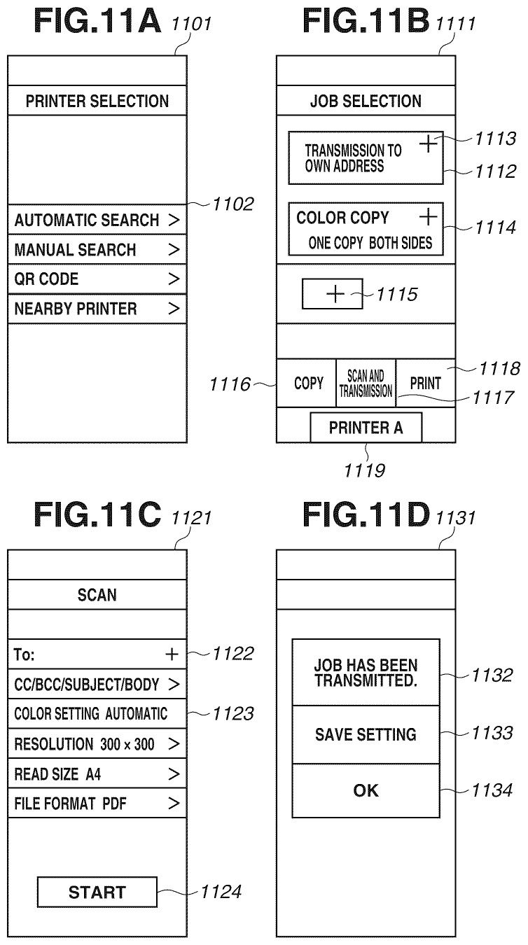

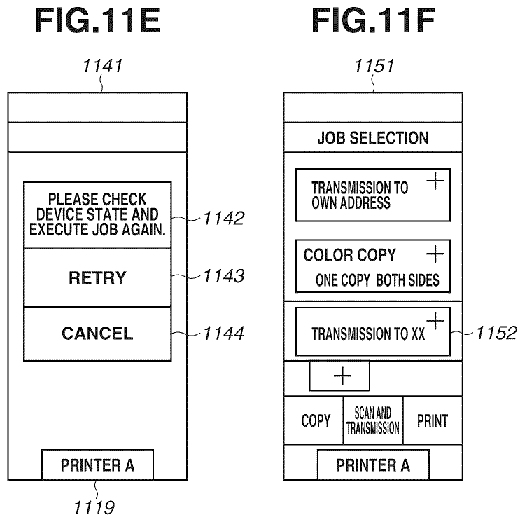

The user performs operation to acquire the connection information from the image forming apparatus 104 by using the data processing apparatus 101. FIG. 11A illustrates an example of a connection screen to the image forming apparatus 104 displayed on the display 214 of the data processing apparatus 101. In a connection screen 1101, selection items 1102 for a device connection method include “automatic search”, “manual search”, “QR code®”, and “nearby printer”.

In the “automatic search”, the device connection unit 404 searches for the image forming apparatus 104 communicable with the data processing apparatus 101 on the network 103 via the wireless LAN terminal 102 by using Wi-Fi ® or the like based on multicast Domain Name System (mDNS). The user selects the image forming apparatus 104 detected by the search to establish connection with the image forming apparatus 104 via the device connection unit 404.

In the “manual search”, the user inputs identification information (IP address, etc.) on the image forming apparatus 104 to be connected, by using the input device 215, to establish connection with the image forming apparatus 104 via the device connection unit 404.

In a case of the “QR” code, a QR code holding the identification information of the image forming apparatus 104 is read by a camera mounted on the data processing apparatus 101, to establish connection with the image forming apparatus 104 via the device connection unit 404.

In a case of the “nearby printer”, the user performs operation to bring the data processing apparatus 101 close to the NFC or Bluetooth® LE communication unit of the image forming apparatus 104, to establish connection with the image forming apparatus 104 via the device connection unit 404.

In step S601, the device connection unit 404 determines whether the connection information has been acquired by any of the above-described methods. In a case where the connection information has not been acquired (NO in step S601), the processing returns to step S601, and the device connection unit 404 continuously waits for acquisition of the connection information. In a case where the connection information has been acquired (YES in step S601), the processing proceeds to step S602. In step S602, the device connection unit 404 searches for the image forming apparatus 104 based on the acquired connection information. In step S603, the device connection unit 404 determines whether the image forming apparatus 104 has been detected. In a case where the image forming apparatus 104 has been detected (YES in step S603), in step S604, the device connection unit 404 starts connection with the image forming apparatus 104. Then the processing ends. In a case where the image forming apparatus 104 has not been detected (NO in step S603), an error is notified to the user, and the processing ends.

FIGS. 11B and 11C each illustrate an example of a screen displayed by the UI control unit 402 when the data processing apparatus 101 receives job setting from the user and transmits the job information to the image forming apparatus 104.

FIG. 11B illustrates a job selection screen 1111 that is a screen for the user to select a desired job. “Favorite” buttons 1112 and 1114 are buttons to call the job setting previously registered by the user. When any of the “favorite” buttons 1112 and 1114 is pressed, the screen changes to a job setting screen reflecting the registered job setting information. An edit button 1113 is a button to change setting associated with the corresponding “favorite” button. An addition button 1115 is a button to newly add a “favorite” button. When the addition button 1115 is pressed, the screen changes to a screen to register setting. Preset buttons 1116 to 1118 are buttons each associated with default setting values. When any of the preset buttons 1116 to 1118 is pressed, a setting screen of a corresponding function reflecting the default setting values is displayed. As an example, buttons for a copy function, a scan and transmission function, and a print function are displayed. A target image forming apparatus button 1119 displays information on the image forming apparatus 104 connected by the connection processing illustrated in FIG. 6. The image forming apparatus 104 displayed in the target image forming apparatus button 1119 is a job information transmission target. The target image forming apparatus can be changed by pressing the target image forming apparatus button 1119.

A scan setting screen 1121 is a setting screen displayed when the scan and transmission button 1117 is selected in the job selection screen 1111. The scan setting screen 1121 includes an item 1122 for setting of a transmission destination of an image, and an item 1123 for setting of scanning. The user performs job setting by selecting each of the items. When a start button 1124 is pressed, job information is configured based on the setting received from the user in the scan setting screen 1121, and the job information is transmitted to the image forming apparatus 104.

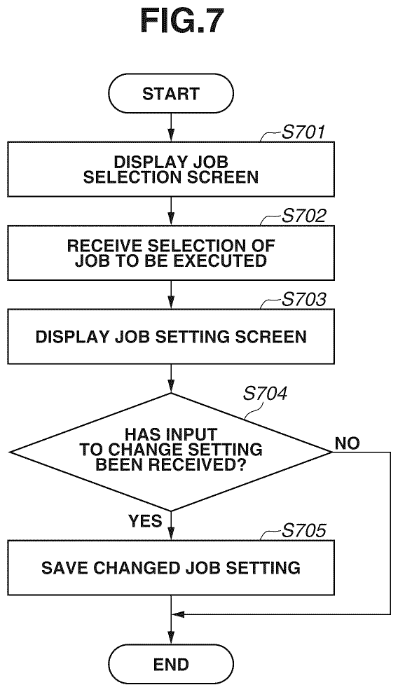

FIG. 7 is a flowchart illustrating processing by the data processing apparatus 101 to receive the job setting from the user. Operation illustrated in FIG. 7 is realized when the CPU 202 reads out programs to implement control modules, stored in the ROM 203 or the storage device 209 to the RAM 204, and executes the programs. As an example, a case where the scan and transmission button 1117 is selected in the job selection screen 1111 will be described.

In step S701, the UI control unit 402 displays the job selection screen 1111 for selection of the job to be executed. In step S702, the UI control unit 402 receives selection of the job to be executed, from the user. When selection of the scan and transmission button 1117 by the user is received and selection of the job to be executed is thus received, in step S703, the UI control unit 402 displays the scan setting screen 1121.

In step S704, the UI control unit 402 determines whether input to change the transmission destination setting or the scan setting has been received. In a case where the input has been received (YES in step S704), the processing proceeds to step S705. In step S705, the UI control unit 402 temporarily saves the job setting information including the changed setting in the RAM 204. Then the processing ends. In a case where the input has not been received (NO in step S704), the processing ends.

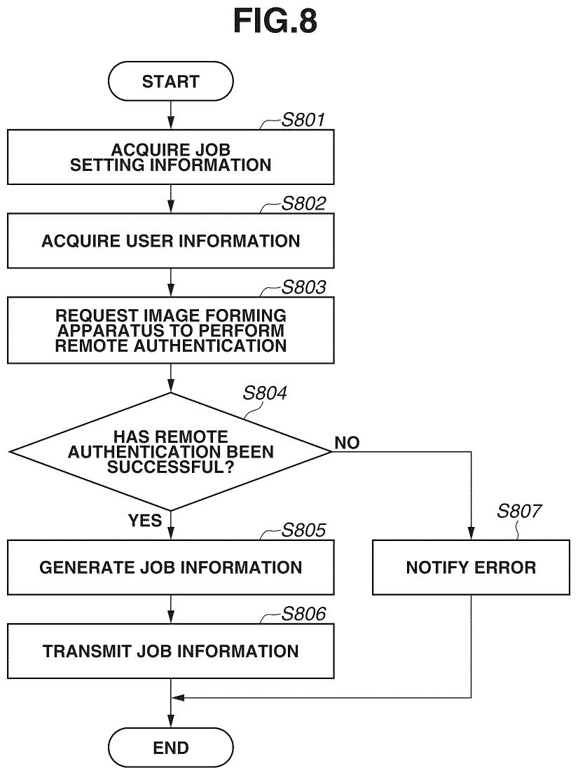

FIG. 8 is a flowchart illustrating processing by the data processing apparatus 101 to transmit the job information to the image forming apparatus 104. Operation illustrated in FIG. 8 is realized when the CPU 202 reads out programs to implement control modules, stored in the ROM 203 or the storage device 209 to the RAM 204, and executes the programs. As an example, a case where pressing of the start button 1124 is received in the scan setting screen 1121 will be described.

In a case where pressing of the start button 1124 by the user is received in the scan setting screen 1121, in step S801, the job control unit 407 acquires the job setting information set in the setting screen, via the UI control unit 402. In the following, the transmission destination and the scan setting necessary for execution of the job are collectively referred to as job setting information. Subsequently, in step S802, the job control unit 407 acquires user information such as a user name and a password stored in the RAM 204 or the storage device 209. In step S803, the job control unit 407 requests the image forming apparatus 104 to perform remote authentication. The remote authentication is authentication to permit start of communication between the data processing apparatus 101 and the image forming apparatus 104. When the remote authentication has been successful, the image forming apparatus 104 can receive the job information from the data processing apparatus 101. In step S804, the job control unit 407 determines whether the remote authentication has been successful. When a notification of remote authentication failure is received from the job control unit 407 (NO in step S804), in step S807, the UI control unit 402 displays an error screen on the display 214. Then the processing ends. In a case where the remote authentication has been successful (YES in step S804), in step S805, the job control unit 407 generates job information based on the acquired job setting information, the acquired user information, and the like. In step S806, the job control unit 407 transmits the job information to the connected image forming apparatus 104. Then the processing ends.

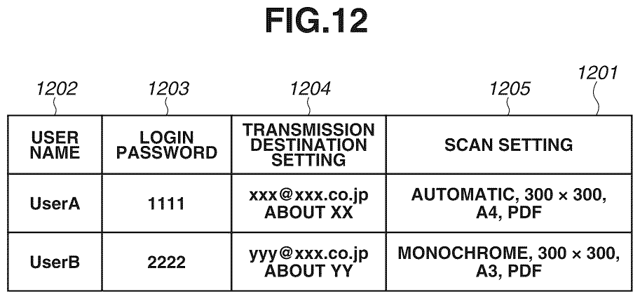

FIG. 12 illustrates an example of a table indicating a configuration of the job information transmitted by the data processing apparatus 101. In a job information table 1201, a column 1202 indicates a user name, a column 1203 indicates a login password, a column 1204 indicates transmission destination setting, and a column 1205 indicates scan setting. One row indicates one piece of job information. In this example, job information on a scan and transmission job is illustrated, and a copy job and a print job each have a similar configuration.

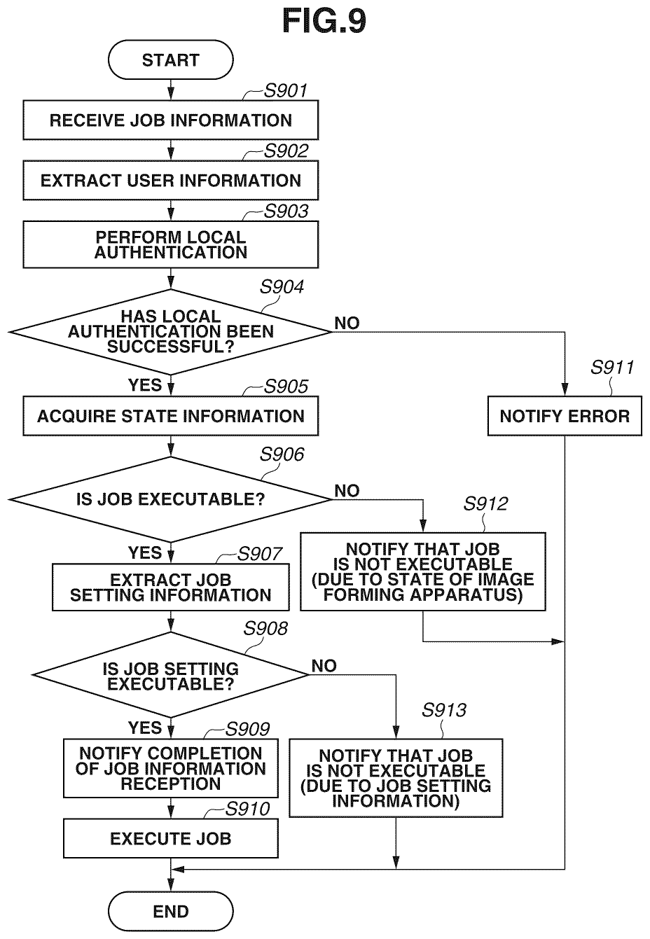

FIG. 9 is a flowchart illustrating processing by the image forming apparatus 104 to receive the job information.

Operation illustrated in FIG. 9 is realized when the CPU 302 reads out programs to implement control modules, stored in the ROM 304 or the HDD 305 to the RAM 303, and executes the programs.

In step S901, the job control unit 507 receives the job information from the data processing apparatus 101 via the network control unit 505. Subsequently, in step S902, the job control unit 507 extracts the user information from the received job information. In step S903, the job control unit 507 causes the authentication unit 503 to perform local authentication with the extracted user information. The local authentication is authentication to permit the user to perform operation on the operation unit 307 of the image forming apparatus 104. In step S904, the job control unit 507 determines whether the local authentication has been successful. In a case where the local authentication has failed (NO in step S904), in step S911, the job control unit 507 notifies an error to the data processing apparatus 101. Then the processing ends. In a case where the local authentication has been successful (YES in step S904), in step S905, the job control unit 507 acquires state information about the image forming apparatus 104. The state information about the image forming apparatus 104 includes information indicating whether the image forming apparatus 104 is executing another job, information indicating whether another user is logged in to the image forming apparatus 104, and the like.

In step S906, the job control unit 507 determines whether the job is executable, based on the acquired state information about the image forming apparatus 104. In a case where the image forming apparatus 104 is executing another job or in a case where another user is logged in to the image forming apparatus 104, the job control unit 507 determines that the job is not executable (NO in step S906), the processing proceeds to step S912. In step S912, the job control unit 507 notifies the data processing apparatus 101 that the job is not executable due to the state of the image forming apparatus 104. The processing then ends. In a case where the job is executable (YES in step S906), the processing proceeds to step S907. In step S907, the job control unit 507 extracts the job setting information. In step S908, the job control unit 507 determines whether the job setting is executable by the image forming apparatus 104.

In a case where the job setting is executable (YES in step S908), the processing proceeds to step S909. In step S909, the job control unit 507 notifies the data processing apparatus 101 of completion of the job information reception. In step S910, the job is executed, and the processing then ends. At this time, for example, the scan processing is performed with the scan setting included in the job information, and image data generated by scanning is transmitted to a transmission destination included in the job information.

In a case where the job setting is not executable (NO in step S908), the processing proceeds to step S913. In step S913, the job control unit 507 notifies the data processing apparatus 101 of an error caused by the job setting information. The processing then ends.

In the present exemplary embodiment, the determination processing in step S906 and the determination processing in step S908 may be performed in reverse order. The image forming apparatus 104 can execute the job based on the job information transmitted from the data processing apparatus 101 by the above-described processing in the flowchart. Further, in a case where the image forming apparatus 104 cannot execute the received job, the image forming apparatus 104 can notify the data processing apparatus 101 that the error is caused by the job setting information or the state of the image forming apparatus 104.

FIGS. 11D to 11F each illustrate an example of a screen illustrating processing by the data processing apparatus 101 in response to the result of the job information reception by the image forming apparatus 104, and each illustrate an example of a screen displayed by the UI control unit 402.

FIG. 11D illustrates a screen displayed by the UI control unit 402 in a case where the image forming apparatus 104 completes the job information reception, namely, in a case where the job information transmitted by the data processing apparatus 101 has been successfully input to the image forming apparatus 104. A job transmission completion screen 1131 includes a message 1132 indicating completion of the job transmission without an error, a save button 1133 to save the transmitted job setting information in the data processing apparatus 101, and an OK button 1134 to end the processing without saving the job setting information. When the save button 1133 is pressed, the job setting information is saved in the application 401, and a “favorite” button 1152 to call the saved setting information is newly registered in the job selection screen as illustrated in a job selection screen 1151. When the “favorite” button 1152 is pressed, the job setting screen reflecting the saved setting information is displayed. A screen for input of a button name to be displayed on the “favorite” button may be displayed when the save button 1133 is pressed.

FIG. 11E illustrates a screen displayed by the UI control unit 402 in a case where the image forming apparatus 104 having received the job information cannot execute the received job due to execution of another job or the like. A retry screen 1141 includes a message 1142 indicating that the job is not executable due to the state of the image forming apparatus 104, a retry button 1143 to retransmit the transmitted job information, and a cancel button 1144 to end the processing without saving the setting information. The transmission target of the job information may be configured to be changeable by pressing of the target image forming apparatus button 1119 before pressing of the retry button 1143. This makes it possible to transmit the job information to another image forming apparatus without discarding the job setting information.

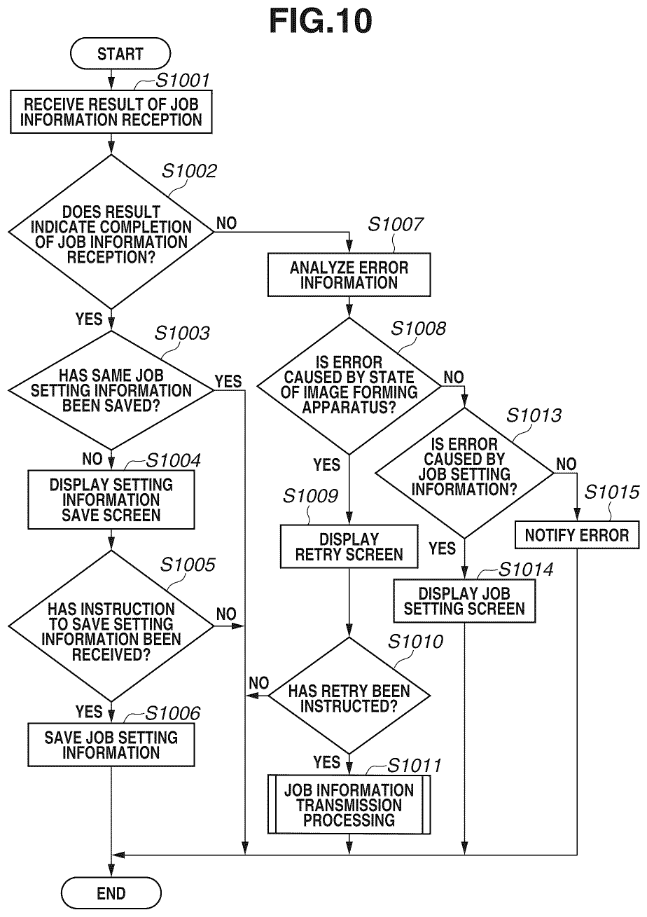

FIG. 10 is a flowchart illustrating the processing by the data processing apparatus 101 in response to the result of the job information reception by the image forming apparatus 104. Operation illustrated in FIG. 10 is realized when the CPU 202 reads out programs to implement control modules, stored in the ROM 203 or the storage device 209 to the RAM 204, and executes the programs.

In step S1001, the job control unit 407 receives the result of the job information reception transmitted from the image forming apparatus 104 via the network I/F 205. In step S1002, the job control unit 407 determines whether the result indicates completion of the job information reception corresponding to step S909. In a case where the result indicates completion of the reception (YES in step S1002), the processing proceeds to step S1003. In step S1003 the job setting management unit 406 determines whether the job setting information stored in the application 401 includes the job setting information temporarily stored in the RAM 204 in step S705. In a case where the setting information has been saved (YES in step S1003), the processing ends. In a case where the setting information has not been saved (NO in step S1003), the processing proceeds to step S1004. In step S1004, the UI control unit 402 displays the job transmission completion screen 1131 to inquire the user whether to save the job setting information. In step S1005, the UI control unit 402 determines whether an instruction to save the setting information from the user has been received on the job transmission completion screen 1131. In a case where the save instruction has been received (YES in step S1005), the processing proceeds to step S1006. In step S1006, the UI control unit 402 saves the job setting information temporarily saved in the RAM 204, in the storage device 209. Otherwise (NO in step S1005), the processing ends. The save instruction specifically indicates pressing of the save button 1133. A button to call the saved job setting information is displayed on the job selection screen. The example in which the job setting information is saved in response to the reception of the save instruction from the user is described; however, the job setting information may be automatically saved without receiving the user instruction.

In a case where the job information reception is not completed in step S1002 (NO in step S1002), the processing proceeds to step S1007. In step S1007, the job control unit 407 analyzes error information. At this time, it is determined whether notification corresponding to step S913 or notification corresponding to step S912 has been received from the image forming apparatus 104. In step S1008, the job control unit 407 determines whether the error is caused by the state of the image forming apparatus 104, based on an analysis result. In a case where the error is caused by the state of the image forming apparatus 104 (YES in step S1008), in step S1009, the UI control unit 402 displays the retry screen 1141. In step S1010, the UI control unit 402 determines whether a retry instruction from the user has been received in the retry screen 1141. In a case where the retry instruction has been received (YES in step S1010), the processing proceeds to step S1011. In step S1011, the job control unit 407 performs processing to transmit the job information saved in the RAM 204 to the image forming apparatus 104. In a case where the retry instruction has not been received (NO in step S1010), the processing ends. More specifically, when pressing of the retry button 1143 by the user is received, the job control unit 407 transmits the job setting information temporarily saved in the RAM 204 in step S705, to the image forming apparatus 104. The processing is the same as the processing in the flowchart of FIG. 8. Therefore, descriptions of the processing are omitted.

In a case where it is determined in step S1008 that the error is not caused by the state of the image forming apparatus 104 (NO in step S1008), the processing proceeds to step S1013. In step S1013, the job control unit 407 determines whether the error is caused by the job setting information. In a case where the error is caused by the job setting information (YES in step S1013), the processing proceeds to step S1014. In step S1014, the UI control unit 402 displays the job setting screen (e.g., scan setting screen 1121). The setting screen displayed at this time may be a setting screen reflecting the transmitted job setting information, or a setting screen in which all of the setting values are cleared.

In a case where it is determined in step S1013 that the error is not caused by the job setting information (NO in step S1013), the processing proceeds to step S1015. In step S1015, an error is notified to the user, and then the processing ends.

By the above-described processing in the flowchart, in a case where the condition that the data processing apparatus has successfully input the job to the image forming apparatus is satisfied, the job setting information can be saved in the data processing apparatus, and the usable job setting information can be easily called. The setting information can be saved only in the case where the job input has been successfully input, and the job setting information is setting information not saved in the data processing apparatus. This makes it possible to prevent unnecessary setting information from being saved.

In the case where the data processing apparatus has failed to input the job to the image forming apparatus, the processing can be changed based on the type of the error. More specifically, it is configured that, in the case where the error is caused by execution of another job by the image forming apparatus, namely, in the case where the error is caused by the state of the image forming apparatus, the job information can be retransmit. This makes it possible to retransmit the job information when the image forming apparatus can execute the job, and it is unnecessary to perform setting again from the beginning in the data processing apparatus. In contrast, in the case where the error is caused by the job setting information, the user is caused to perform setting again in the data processing apparatus.

In the above-described exemplary embodiment, the example in which the job setting information can be saved in the case where the job has been successfully input; however, the configuration is not limited thereto. It may be inquired to the user whether to register the job setting information at the time when the data processing apparatus successfully transmits the job information to the image forming apparatus, it may be inquired to the user whether to register the job setting information at the time when the image forming apparatus starts the job based on the job information, or it may be inquired to the user whether to register the job setting information in a case where the image forming apparatus having received the job information completes execution of the job without an error.

### Other Exemplary Embodiments

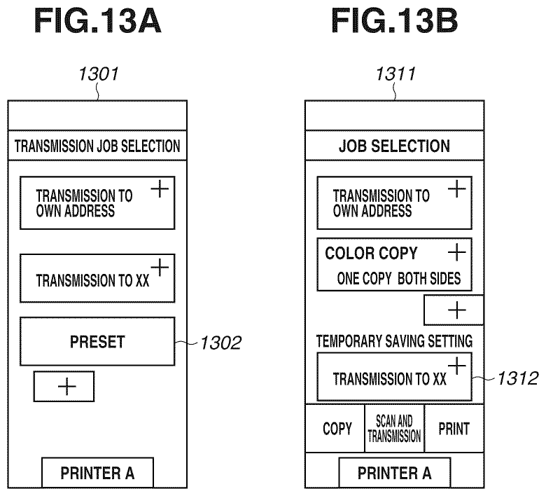

In the first exemplary embodiment, the favorite buttons for the plurality of functions such as the print function, the scan and transmission function, and the copy function are displayed in the same job selection screen 1111; however, different screens for the respective functions may be provided. FIG. 13A illustrates an example of the screen. A transmission job selection screen 1301 is a screen displaying the favorite buttons in the scan and transmission function. In the transmission job selection screen 1301, only buttons for jobs using the scan and transmission function are displayed, and a preset button 1302 is a button to open the setting screen with default setting values. The favorite button to call the job setting information saved in step S1006 is displayed on screen of the corresponding function.

Further, in the first exemplary embodiment, the example in which, when the image forming apparatus having received the job information cannot execute the job, retry can be instructed from the data processing apparatus is described; however, the configuration is not limited thereto. The data processing apparatus 101 may temporarily save the transmitted job information to enable the transmitted job information to be called from the job selection screen. FIG. 13B illustrates an example of the screen. A job selection screen 1311 includes a button 1312 to call the temporarily saved job setting information. When the button 1312 is pressed, the job setting screen reflecting the saved setting information is displayed. The button 1312 may be hidden, for example, when the application 401 is terminated in the data processing apparatus 101 or is performed on the background, and the saved job setting information may be deleted. Further, in a case where the button 1312 is selected and the job is executed, the saved job setting information may be deleted.

Embodiments of the present disclosure are also realized by supplying software (programs) implementing the functions of the above-described exemplary embodiment to a system or an apparatus via a network or various kinds of storage media, and causing a computer (or CPU, microprocessor unit (MPU), etc.) of the system or the apparatus to read out and execute the programs. In this case, embodiments of the present disclosure include the computer programs and the storage medium storing the computer programs.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A method of controlling a data processing apparatus, the method comprising:
displaying a first button for calling a first setting previously registered by a user;
receiving change operation for changing the first setting;
performing execution processing for transmitting a job from the data processing apparatus to an image forming apparatus outside the data processing apparatus after operation to the first button by the user is received;
performing first determination processing for determining whether the job transmitted from the data processing apparatus has been successfully received by the image forming apparatus and performing second determination processing for determining whether the job transmitted from the data processing apparatus is a job based on a second setting which is a setting that has been changed from the first setting by the change operation; and
performing, based on a result of the first determination processing corresponding to a fact that the job transmitted from the data processing apparatus has been successfully received by the image forming apparatus and a result of the second determination processing corresponding to a fact that the job transmitted from the data processing apparatus is a job based on the second setting, predetermined control for newly displaying, in the data processing apparatus, on a screen that includes the first button, a second button different from the first button for calling a setting corresponding to the job transmitted from the data processing apparatus, and not performing the predetermined control in a case where the result of the first determination processing corresponds to a fact that the job transmitted from the data processing apparatus has been successfully received by the image forming apparatus but the second determination result corresponds to a fact that the job transmitted from the data processing apparatus is a job based on the first setting, and in a case where the result of the first determination processing corresponds to a fact that the job transmitted from the data processing apparatus has not been successfully received by the image forming apparatus.

2. The method according to claim 1, further comprising receiving a result of reception of the job by the image forming apparatus from the image forming apparatus,
wherein the first determination processing is executed based on the received result.

3. The method according to claim 1, further comprising displaying, in a case where the result of the first determination processing corresponds to the fact that the job transmitted from the data processing apparatus has not been successfully received by the image forming apparatus, a screen corresponding to the fact that the job transmitted from the data processing apparatus has not been successfully received by the image forming apparatus.

4. The method according to claim 1, further comprising displaying, in a case where the result of the first determination processing corresponds to the fact that the job transmitted from the data processing apparatus has not been successfully received by the image forming apparatus and the unsuccess of the reception of the job by the image forming apparatus is due to a state of the image forming apparatus, a screen based on a fact that the unsuccess of the reception of the job by the image forming apparatus is due to a state of the image forming apparatus.

5. The method according to claim 4, wherein the screen displayed based on the fact that the unsuccess of the reception of the job by the image forming apparatus is due to a state of the image forming apparatus includes a button for retransmitting the job.

6. The method according to claim 4, wherein the screen displayed based on the fact that the unsuccess of the reception of the job by the image forming apparatus is due to a state of the image forming apparatus includes a button for changing a transmission target of the job.

7. The method according to claim 4, wherein the screen displayed based on the fact that the unsuccess of the reception of the job by the image forming apparatus is due to a state of the image forming apparatus is a screen for input of a setting corresponding to a job to be newly transmitted.

8. The method according to claim 1, wherein the predetermined control includes control for saving setting corresponding to the executed job, in the data processing apparatus.

9. The method according to claim 1, further comprising displaying, based on the result of the first determination processing corresponding to the fact that the job transmitted from the data processing apparatus has been successfully received by the image forming apparatus and a result of the second determination processing corresponding to the fact that the job transmitted from the data processing apparatus is a job based on the second setting, a predetermined screen for receiving operation from the user,
wherein, in a case where a first operation is performed on the predetermined screen, the predetermined control is performed, and
wherein, in a case where a second operation is performed on the predetermined screen, the predetermined control is not performed.

10. The method according to claim 1, wherein the predetermined control includes processing for displaying a screen for input of a name of a button for calling a setting corresponding to the job transmitted from the data processing apparatus.

11. The method according to claim 1, wherein the job is a print job for performing printing, a scan job for performing scanning, or a copy job for performing copying.

12. The method according to claim 1, further comprising performing authentication for permitting start of communication between the data processing apparatus and the image forming apparatus outside the data processing apparatus,
wherein the job is transmitted to the image forming apparatus after the authentication is successful.

13. The method according to claim 1, wherein, when the predetermined control is performed, the second button is newly displayed below the first button.

14. The method according to claim 1, further comprising:
performing, in a case where the result of the first determination processing corresponds to the fact that the job transmitted from the data processing apparatus has not been successfully received by the image forming apparatus, at least one of third determination processing for determining whether the unsuccessful reception of the job transmitted from the data processing apparatus by the image forming apparatus is due to a state of the image forming apparatus, and fourth determination processing for determining whether the unsuccessful reception is due to a setting of the job transmitted from the data processing apparatus;
displaying a first screen including a button for retransmitting the job in a case where a result of the third determination processing corresponds to a fact that the unsuccessful reception is due to the state of the image forming apparatus; and
displaying a second screen for making a setting for the job again in a case where a result of the fourth determination processing corresponds to a fact that the unsuccessful reception is due to a setting of the job transmitted from the data processing apparatus.

15. The method according to claim 14, further comprising notifying the user of an error, in a case where the result of the third determination processing corresponds to the fact that the unsuccessful reception is not due to the state of the image forming apparatus and the result of the fourth determination processing corresponds to the fact that the unsuccessful reception is not due to a setting of the job transmitted from the data processing apparatus.

16. A data processing apparatus, comprising:
a display;
one or more processors; and
one or more memories storing instructions that, when executed by the one or more processors, cause the data processing apparatus to:
display, on the display, a first button for calling a first setting previously registered by a user;
receive change operation for changing the first setting;
perform execution processing for transmitting a job from the data processing apparatus to an image forming apparatus outside the data processing apparatus after operation to the first button by the user is received;
perform first determination processing for determining whether the job transmitted from the data processing apparatus has been successfully received by the image forming apparatus and perform second determination processing for determining whether the job transmitted from the data processing apparatus is a job based on a second setting which is a setting that has been changed from the first setting by the change operation; and
perform, based on a result of the first determination processing corresponding to a fact that the job transmitted from the data processing apparatus has been successfully received by the image forming apparatus and a result of the second determination processing corresponding to a fact that the job transmitted from the data processing apparatus is a job based on the second setting, predetermined control for newly displaying, in the data processing apparatus, on a screen that includes the first button, a second button different from the first button for calling a setting corresponding to the job transmitted from the data processing apparatus, and not perform the predetermined control in a case where the result of the first determination processing corresponds to a fact that the job transmitted from the data processing apparatus has been successfully received by the image forming apparatus but the second determination result corresponds to a fact that the job transmitted from the data processing apparatus is a job based on the first setting, and in a case where the result of the first determination processing corresponds to a fact that the job transmitted from the data processing apparatus has not been successfully received by the image forming apparatus.

17. A non-transitory computer-readable storage medium storing one or more programs including instructions, which when executed by one or more processors of a data processing apparatus, cause the data processing apparatus to perform:
displaying a first button for calling a first setting previously registered by a user;
receiving change operation for changing the first setting;
performing execution processing for transmitting a job from the data processing apparatus to an image forming apparatus outside the data processing apparatus after operation to the first button by the user is received;
performing first determination processing for determining whether the job transmitted from the data processing apparatus has been successfully received by the image forming apparatus and performing second determination processing for determining whether the job transmitted from the data processing apparatus is a job based on a second setting which is a setting that has been changed from the first setting by the change operation; and
performing, based on a result of the first determination processing corresponding to a fact that the job transmitted from the data processing apparatus has been successfully received by the image forming apparatus and a result of the second determination processing corresponding to a fact that the job transmitted from the data processing apparatus is a job based on the second setting, predetermined control for newly displaying, in the data processing apparatus, on a screen that includes the first button, a second button different from the first button for calling a setting corresponding to the job transmitted from the data processing apparatus, and not performing the predetermined control in a case where the result of the first determination processing corresponds to a fact that the job transmitted from the data processing apparatus has been successfully received by the image forming apparatus but the second determination result corresponds to a fact that the job transmitted from the data processing apparatus is a job based on the first setting, and in a case where the result of the first determination processing corresponds to a fact that the job transmitted from the data processing apparatus has not been successfully received by the image forming apparatus.
